(19) United States
(12) Patent Application Publication
(10) Pub. No.: US 2026/0180947 A1
(43) Pub. Date: Jun. 25, 2026

(54) AUTONOMOUS INTELLIGENT WORKFLOW COMMUNICATIONS AGENT

(71) Applicant: ADVANCED MICRO DEVICES, INC., Santa Clara, CA (US)

(72) Inventors: SiMing Chen, Shanghai (CN); Ning Zhou, Shanghai (CN); JinYing Cheng, Shanghai (CN)

(21) Appl. No.: 18/987,786

(22) Filed: Dec. 19, 2024

(51) Int. Cl. H04L 51/21; G06F 40/205

(52) U.S. Cl. CPC H04L 51/21; G06F 40/205

(57) ABSTRACT

Systems and methods are described for a workflow communications agent. The workflow communications agent receives a message that contains task-related content and parses the message to determine whether the task-related content includes predefined segments associated with one or more predefined instruction sets. If predefined segments are identified, the WCA initiates execution of the associated predefined instruction set(s). If no predefined segments are detected, the task-related content is provided to one or more large language models (LLMs) to determine whether the content can be associated with a predefined instruction set. In certain scenarios, the WCA generates new instruction sets based on contents of the task-related content if needed, and initiates execution of the predefined or newly generated instruction sets.

### BACKGROUND

Modern industries increasingly rely on automated systems to manage complex workflows, communications, and task execution across fields as varied as system design and development, finance, and project management. As the scale of projects and operational complexity grows, particularly in fields involving large-scale hardware and software design, the demand for human resources to manage communications, monitor tasks, and execute predefined workflows has become a significant challenge.

Engineers and other professionals are often tasked with overseeing highly intricate workflows involving numerous steps, each of which requires monitoring and execution. Such workflows typically involve various types of communication, including the processing of task-related instructions, status updates, and error reports. Human operators must not only interpret these communications but also manually initiate responses, trigger execution of scripts (predefined instructions and/or sets of instructions), or troubleshoot errors, leading to delays, inefficiencies, and increased resource consumption.

Furthermore, as systems become more sophisticated, they may produce an overwhelming amount of data and communications that require processing. This growing complexity exacerbates the strain on human resources, often requiring teams to rely on manual effort for repetitive and routine tasks, such as parsing messages or initiating workflow steps based on predefined instructions.

Existing automation tools and systems provide limited solutions to this problem, often focusing on specific workflows or tasks without offering the flexibility needed to adapt to dynamic communication environments or handle a wide range of inputs. Moreover, current solutions may lack the ability to intelligently interpret complex, non-standardized instructions, leading to bottlenecks in task execution and mismanagement of workflow priorities.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a communication workflow 100 between multiple workflow communications agents and/or their corresponding human users in a manner facilitating managed workflow communications, in accordance with some embodiments.

FIG. 2 illustrates an embodiment of a workflow communications agent (WCA) 200, which automates communication and task execution across various domains in accordance with some embodiments.

FIG. 3 illustrates an example workflow of the WCA 200 from FIG. 1, including message parsing, task interpretation, and execution, in accordance with some embodiments.

FIG. 4 illustrates an example workflow of a distributed network of workflow communications agents, in accordance with some embodiments.

FIG. 5 is a block diagram of a processing system designed to implement one or more instances of a workflow communications agent, in accordance with one or more embodiments.

FIG. 6 illustrates an operational flow diagram of a routine for processing task-related content via a workflow communications agent, in accordance with one or more embodiments.

### DETAILED DESCRIPTION

As pressure to reduce human involvement in routine operations increases, there is a growing need for a more sophisticated and intelligent system capable of autonomously managing communication workflows, processing a variety of inputs, and efficiently executing tasks across multiple domains without extensive human oversight.

As used herein, a domain refers to a distinct area of operation or specialization within which specific tasks, processes, or workflows are performed. Domains may encompass various fields such as physical electronics and/or semiconductor design, project management, finance, human resources management, or other fields requiring structured communication and task management. Each domain is characterized by its own set of requirements, workflows, and communication protocols, which may be tailored to meet the operational needs of a particular industry or application. A domain may include both technical and non-technical fields where automation can enhance efficiency by managing communication-driven workflows. For example, in physical design engineering, a domain might encompass tasks such as timing analysis, congestion analysis, or routing.

Embodiments of techniques described herein provide systems and methods for autonomously managing communication workflows and executing tasks across multiple domains, significantly reducing the need for manual human intervention by leveraging intelligent automation to process both predefined and dynamically generated instructions. By integrating communication parsing, task orchestration, and workflow execution capabilities, such embodiments facilitate more efficient handling of routine operations while allowing human resources to focus on complex, high-level tasks. The described techniques are adaptable to different environments, supporting various communication interfaces and enabling integration with existing infrastructure, thereby offering improved flexibility, scalability, and operational efficiency.

As used herein, a workflow communications agent (WCA) is an executable component configured to manage, interpret, and execute task-related communications between human users and/or other WCAs within a networked environment. Each WCA automates the handling of messages containing instructions, using both predefined instruction sets and dynamically generated instructions to process and respond to tasks. In certain embodiments, a WCA utilizes one or more large language models (LLMs) to interpret unstructured or ambiguous content, identifying relevant instructions even in non-standardized messages. In some embodiments, WCAs coordinate task execution across multiple agents and communicate status updates, results, or additional instructions as needed. In various embodiments, each WCA operates across one or more processors, potentially in multi-operating system environments, and may interact with other system components such as memory, processors, and specific tools or applications to fulfill its assigned tasks.

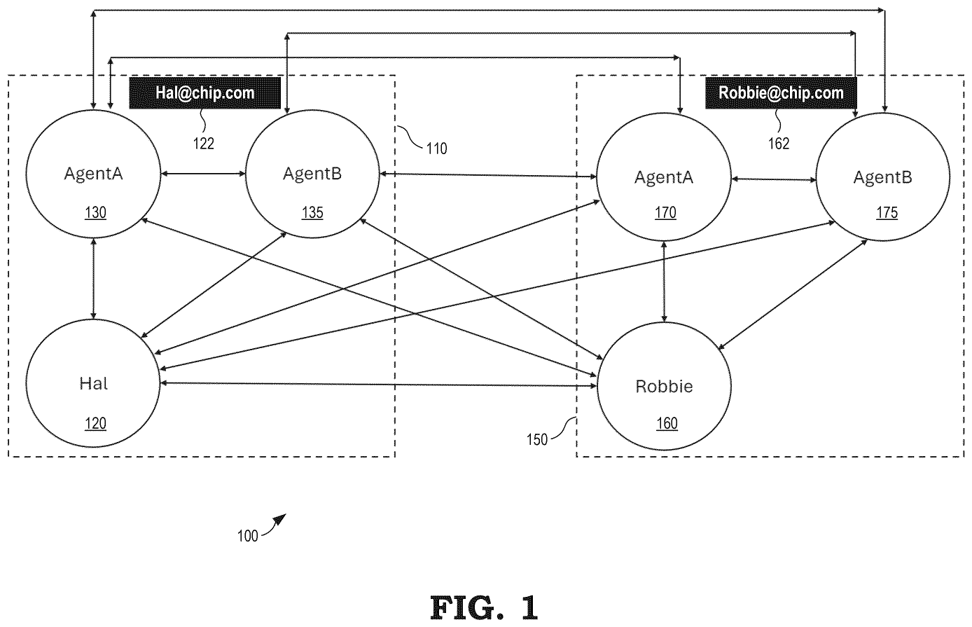

FIG. 1 illustrates a communication workflow 100 between multiple workflow communications agents and/or their corresponding human users in a manner facilitating managed workflow communications, in accordance with some embodiments. The system includes two distinct domains, indicated generally at 110 and 150, each representing a separate area of operation. Each domain includes two workflow communications agents that coordinate communications between human users and external systems.

Within domain 110, two workflow communications agents identified as AgentA 130 and AgentB 135 are configured to manage communications and tasks on behalf of a user Hal 120. Similarly, in domain 150, two workflow communications agents identified as AgentA 170 and AgentB 175 handle communications and tasks on behalf of another user Robbie 160. The workflow communications agents in each domain autonomously manage predefined workflows, leveraging communication parsing and task execution functionalities to ensure coordination between human users and their associated tasks.

In the depicted embodiment, user Hal 120 is linked to the workflow communications agents in domain 110 via a first message address 122 (“Hal@chip.com”), while Robbie 160 is connected to the agents in domain 150 via a second message address 162 (“Robbie@chip.com”). These message addresses serve as communication interfaces through which the workflow communications agents receive and process incoming instructions. The workflow communications agents within each domain exchange information with their respective users as well as between themselves, as indicated by the bidirectional arrows between user Hal 120, AgentA 130, AgentB 135, user Robbie 160, AgentA 170, and AgentB 175.

The illustrated communication workflow 100 facilitates cross-domain communication, enabling Hal 120 and Robbie 160 to share task-related information through their respective agents. For instance, AgentA 130 and AgentB 135 in domain 110 communicate with AgentA 170 and AgentB 175 in domain 150 to ensure coordination of tasks that may span across those domains 110, 150. This inter-agent communication allows for collaboration between users located in different domains.

In various embodiments, communication between workflow communications agents is managed autonomously, leveraging parsing and processing capabilities to interpret both predefined and dynamically generated instructions, with each agent capable of handling multiple tasks substantially simultaneously. For example, AgentA 130 in domain 110 can communicate with AgentA 170 in domain 150, exchanging workflow information between Hal 120 and Robbie 160. Additionally, AgentB 135 and AgentB 175 ensure performance of task execution, such as based on sets of instructions that are predefined (e.g., scripts) and/or dynamically generated via a large language model (LLM) or other natural-language processor.

As used herein, a large language model (LLM) refers to a type of machine learning model that is trained on large amounts of textual data and designed to understand, generate, and interpret human language. LLMs are capable of processing complex, context-sensitive instructions and generating responses or actions based on natural language input. In the context of the techniques described herein, an LLM is used to interpret communications that may contain dynamically generated or non-predefined instructions, allowing the system to autonomously convert human language into structured tasks or workflows. The LLM's flexibility enables it to handle a wide range of inputs, including unstructured or partially structured text, making it ideal for environments where users provide instructions that vary in format or detail.

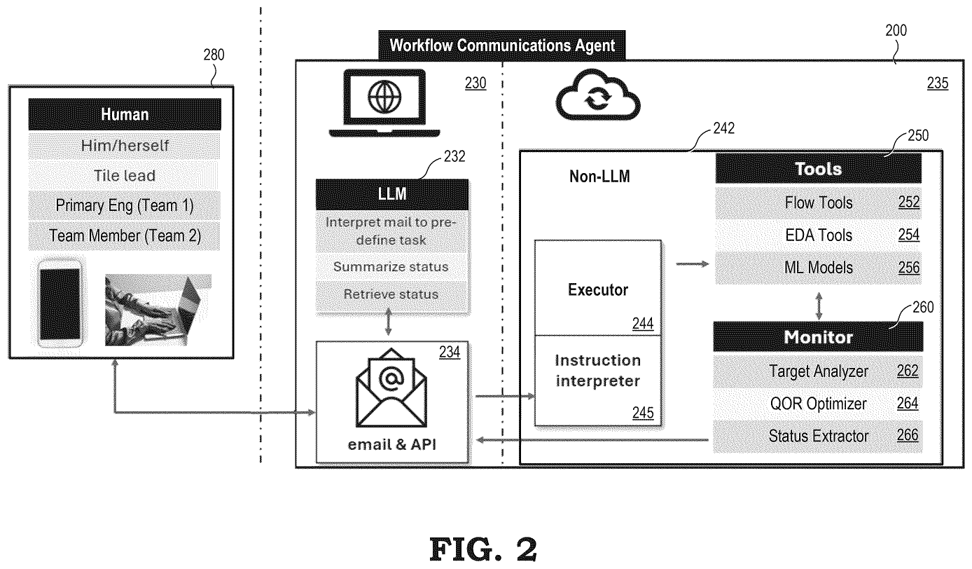

FIG. 2 illustrates an embodiment of a workflow communications agent (WCA) 200, which automates communication and task execution across various domains. In this embodiment, the WCA 200 is depicted as operating with bifurcated functionality across a local server 230 and a remote server 235. However, in other embodiments, the WCA 200 may not be bifurcated in this manner and can be implemented on a single server or system.

While examples described herein utilize email-based messages for ease of illustration, it will be appreciated that in various embodiments, the workflow communications agent 200 may coordinate and manage other types of communications in lieu of or in addition to email messages. For example, the WCA 200 may interact with task management systems via API calls, instant messaging platforms, or integrated project management tools to receive, process, and respond to task-related messages. The WCA 200 may also utilize various communication protocols (such as RESTful web services, JSON-based data exchanges, or direct database interactions) to facilitate workflow coordination. Furthermore, the WCA 200 may coordinate, manage, and operate via one or more messaging services (e.g., Slack, Microsoft Teams, SMS, etc.), allowing for greater flexibility in how tasks are communicated and executed across one or more domains.

In certain embodiments, each respective server 230, 235 may implement a different operating system. For example, in certain embodiments the local server 230 operates using a first operating system (e.g., Microsoft Windows), while remote server 235 operates using a second operating system (e.g., a Linux or other *nix operating system).

In the depicted embodiment, a human user 280 represents an individual who performs various roles within a workflow. This individual may act as a tile lead, a primary engineer for Team 1, or a team member for Team 2. The user can receive communications in any of these capacities, as well as communications directed to the human user 280 in their individual capacity (him/herself), depending on the specific context or job function within the domain. For example, as a tile lead, the user might be responsible for managing tasks related to a specific section of a chip design, while as a primary engineer or team member, they may oversee or contribute to broader project goals.

In the depicted embodiment, interactions of/for the human user 280 with the WCA 200 are typically initiated through email messages, which are processed by the email and application programming interface (API) system 234. The WCA 200 interprets these messages in accordance with the destination role and/or context, ensuring that tasks or updates are handled appropriately based on the context of the communication.

The WCA 200 includes both large language model (LLM) facilities 232 and non-LLM facilities 242. The LLM facilities 232 handle the interpretation of dynamically generated or non-predefined instructions from received messages. These facilities use large language models to translate human language inputs into structured tasks or actions, allowing for a flexible, context-aware response to communications directed at the user in any of their roles (e.g., as a tile lead or as a team member).

In contrast, the non-LLM facilities 242 manage predefined workflows and structured tasks. These include an executor 244, responsible for executing predefined scripts or other predefined sets of instructions, and an instruction interpreter 245, which converts incoming predefined instructions from the email and API system 234 into executable scripts for the executor 244.

The WCA 200 also integrates several tools and monitoring components. The tools 250 include software such as flow tools 252 (for task optimization and compilation), Electronic Design Automation (EDA) tools 254 (used to manage chip design tiles), and machine learning (ML) models 256 (which provide pattern analysis and/or other trained optimizations).

To ensure that tasks are executed properly, the WCA 200 employs a monitor 260, which oversees the performance of tasks and provides feedback. The monitor 260 includes a target analyzer 262 to verify that tasks meet their performance targets, a quality-of-results (QOR) optimizer 264, and a status extractor 266 to retrieve and summarize task status for the human user 280, regardless of their current role.

In the depicted embodiment, the LLM facilities 232 are hosted on the local server 230, while the non-LLM facilities 242 and tools are executed on the remote server 235. However, and as noted above, in various embodiments the WCA 200 may operate on a single server without such bifurcation.

In operation, the WCA 200 facilitates communication and task management via email or other messages. Messages to workflow communications agents in the communications network, whether human-to-agent or agent-to-agent, are received by one or more workflow communications agents (e.g., WCA 200), each of which operates as a node in the agent communications network. Each workflow communications agent within the network is associated with a unique address. In examples described herein a workflow communications agent (such as AgentA 130 or AgentB 175 of FIG. 1, or WCA 200) is referenced by a specific real or virtual address that uniquely identifies the workflow communication agent. For example, in certain embodiments a WCA associated with a particular human user 280 may be identified as some combination of that user's identifier and its own tag (e.g., xxx@domain.com/agent_name). As shown in FIG. 1 with respect to user Hal 120 and user Robbie 160, agent tags (such as “AgentA” and “AgentB”) are unique among agents associated with a particular human user 280, but need not be unique in the overall network, as a message directed to Hal@domain.com/AgentA is routed differently than a message directed to Robbie@domain.com/AgentA.

In the depicted embodiment, the WCA 200 utilizes a dual approach for task handling, in which LLM facilities 232 handle non-predefined instructions and non-LLM facilities 242 manage predefined instructions. When human users (e.g., human user 280) send task instructions via message, these messages are periodically extracted by the email and API system 234, in which natural language instructions are parsed and recorded in one or more structured formats. As non-limiting examples, in various embodiments such instructions may be recorded in comma-separated values format (csv), plain text, Excel (.xls/.xlsx), JavaScript object notation (JSON), or other structured format.

The workflow communications agent (WCA 200) dynamically interprets and routes incoming messages based on their content, utilizing either the LLM facilities 232 or non-LLM facilities 242, depending on the structure and complexity of the instructions provided.

When a message is received by the email and API system 234, the system first analyzes the message content to determine the nature of the instructions. Messages containing predefined keywords or structured instructions are routed to the non-LLM facilities 242 for immediate parsing and execution. On the other hand, unstructured, dynamic, or conversational messages that lack direct keywords are processed by the LLM facilities 232.

Messages containing explicit, predefined instructions (e.g., “run tile build” or “restart flow”) are matched against a set of predefined keywords and task models. For instance, if the message contains the term “run build,” where one or both of “run” and “build” are defined keywords (segments of predefined content) it triggers a script that corresponds to a specific project or task associated with one or both of those keywords, such as:
Instruction Script
Run tile build run_tile_build.csh $project $tile $runDir $disk $params $tag

The instruction interpreter 245 translates these keywords into executable scripts, which are then carried out by the executor 244. For example, in an embodiment the WCA 200 processes the instruction as follows:
Extract the command from the message content using keyword recognition.
Map the extracted command to an existing script or predefined task model.
Execute the script and report back the status to the human user via message.

Continuing the example, a message with a textual body such as “Run tile build for Project X” would directly trigger the run_tile_build.csh script, passing relevant parameters such as the project name and directory paths.

In various embodiments, messages that do not contain explicit keywords or that are phrased in a more conversational or ambiguous manner are routed to the LLM facilities 232. The LLM facilities 232 interpret the content, identifying the underlying task based on context and the user's communication patterns. For example, a message such as “Can you check the status of the latest tile build?” does not map directly to a predefined command but would be interpreted by the LLM as a request for a status report on a recent run.

In this case, the LLM facilities 232 handle the instruction as follows:
Analyze the message using natural language processing to infer the task or request.
Generate an appropriate response or action based on the inferred task.
Convert the inferred task into structured, executable instructions for the non-LLM facilities 242 or return status information directly to the user.

This process allows the WCA to handle a wide range of communication styles, ensuring that tasks are executed efficiently whether the instructions are explicit or implied. The flexibility of the LLM facilities means that even non-technical or vague requests can be processed and responded to appropriately.

Once the task is interpreted—either by keyword-based processing via non-LLM facilities 242 or LLM-driven inference by the LLM facilities 232—it is passed to the executor 244, which carries out the task using the relevant tools such as flow tools 252 or EDA tools 254. Progress is then monitored by the monitor 260, which tracks performance and optimizes the execution where needed.

In certain embodiments, the WCA 200 provides task performance feedback to the human user, summarizing task progress, results, or any errors encountered during execution, whether the instruction was parsed by LLM or non-LLM components.

As will be appreciated, the WCA 200 and one or more of its components (e.g., email and API system 234, LLM facilities 232, non-LLM facilities 242, executor 244, instruction interpreter 245, tools 250, and monitor 260) may, in various embodiments, be implemented as sets of instructions encoded and/or executed via one or more of hardware circuitry, firmware, or software instructions executed by one or more processors, as described in greater detail elsewhere herein.

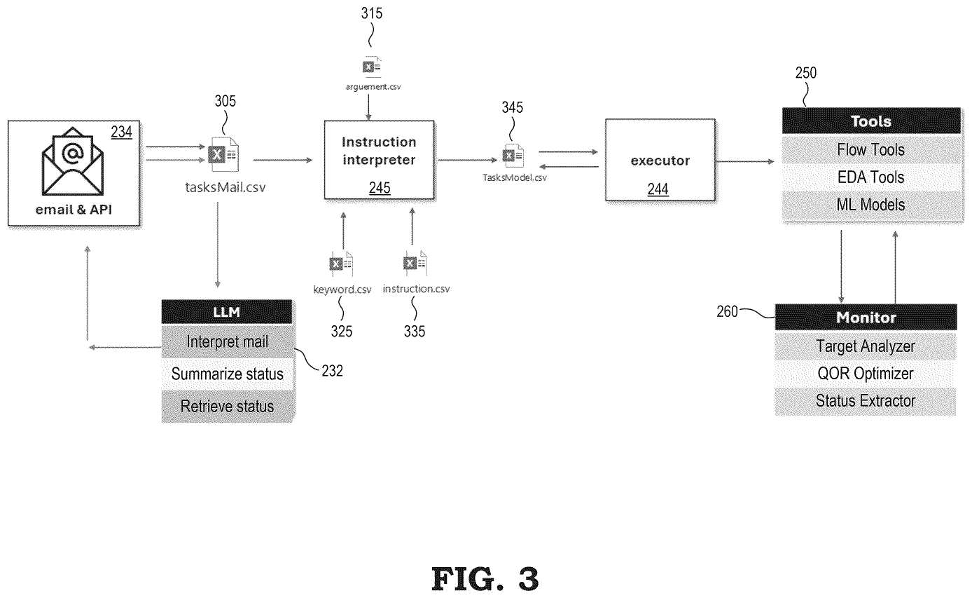

FIG. 3 illustrates an example workflow of the WCA 200 from FIG. 1, including message parsing, task interpretation, and execution, according to some embodiments of the techniques described herein. The WCA processes incoming messages through its parsing and execution facilities, managing both predefined and dynamically generated instruction sets, and integrating tools and monitoring components to manage task-related content.

The WCA 200 receives a message, such as task-related content, via the email and API system 234. The content of this message is extracted and stored in tasks data 305, a .csv file that organizes message information into predefined columns such as sender, time, subject, and instructions. While in the present example the tasks data 305 and other data structures described herein utilize a . csv data structure, it will be appreciated that in various embodiments, other types of data and/or data structures may be utilized in accordance with the described techniques and example presented here. The WCA 200 then begins parsing the message to determine whether the content includes predefined segments.

In particular, the instruction interpreter 245 processes the incoming message via tasks data 305 to determine whether the task-related content contains predefined segments that map to existing instruction sets. During this process, the interpreter accesses various supporting data sources, which in the illustrated example include argument data 315 (containing parameters or arguments associated with the predefined instructions; keyword data 325 (including predefined keywords that trigger specific actions or predefined instruction sets; and instruction data 335 (storing instructions for predefined tasks).

The instruction interpreter 245 cross-references the message content with these data sources to identify corresponding predefined instruction sets. Once identified, in the depicted example the instruction sets are stored in model data 345 (tasksModel.csv), which is then used to direct the execution of tasks by the executor 244.

If the instruction interpreter 245 determines that the task-related content does not contain predefined segments or keywords, the WCA 200 transfers the content to the LLM facilities 232 for further processing. The LLM facilities 232 interpret dynamic, unstructured instructions by analyzing the content for patterns or contexts that suggest an associated instruction set. The LLM facilities 232 may then generate new instruction sets or infer actions based on the task-related content, passing this information back to the instruction interpreter 245 for execution.

In certain embodiments, the LLM facilities 232 are also responsible for summarizing the status of ongoing tasks and retrieving status updates, which are communicated back to the human user via the email and API system 234.

Once the model data 345 is populated with instruction sets, the executor 244 initiates task execution, such as by programmatically interacting with various tools 250. In the depicted example, the tools 250 include EDA tools configured for design generation and optimization; flow tools configured for source code or design code compilation; and one or more tools configured for handling machine learning (ML) models, which may provide additional insights or optimizations during execution. It will be appreciated that in various configurations, embodiments and scenarios, a variety of domain-relevant tools may be programmatically instructed by the WCA 200 based on the model data 345.

The WCA 200 ensures that each tool receives the necessary parameters and instructions to carry out the assigned tasks, including adjusting execution parameters for execution of one or more predefined instruction sets. For example, in certain embodiments, execution parameters for one or more of the tools 250 may be adjusted based on one or more performance metrics. In such embodiments, the WCA 200 may continuously monitor the status and performance of tasks via the monitor 260, which in the depicted example includes a target analyzer, responsible for ensuring that performance targets are met during task execution; a QOR optimizer, which adjusts task execution parameters to improve quality-of-results metrics; and a status extractor, which consolidates and retrieves information about the current status of task execution.

As one example of an operational workflow managed by a WCA (e.g., WCA 200), consider a physical design task related to timing analysis for a chip design. In this example, the human user 280 sends a message to a destination address on the network (e.g., Hal1.chen@chip.com) containing task-related content, such as “Run timing analysis for Tile A on Project X,” to the WCA 200. Upon receiving this message via the email and API system 234, the WCA 200 parses the task-related content to invoke the timing role of Agent 410 and identify predefined keywords (“timing analysis,” “Tile A,” and “Project X”) and maps these keywords to corresponding instruction sets in the model data 345. The instruction interpreter 245 converts the keywords into an executable timing analysis script to effectuate those corresponding instruction sets, and assigns task parameters such as the project directory and tile identifier. The executor 244 then initiates the timing analysis script, interacting with relevant tools (e.g., EDA tools 254) hosted on the remote server 235. Progress and results of the analysis are monitored by the monitor 260, which tracks quality-of-results (QOR) metrics via the QOR optimizer 264 and provides status updates to the human user 280.

As another example scenario, the WCA 200 may facilitate congestion analysis to address physical design challenges. In this scenario, the human user 280 submits a message, “Analyze congestion for latest tile placement,” indicating a desire for the WCA 200 to initiate a process in which the distribution of routing resources and the density of placed components (e.g., macros, standard cells) is evaluated with respect to a specific tile of the chip layout. Due to a lack of explicit predefined keywords in the submitted message, it is provided for parsing to the LLM facilities 232. The LLM facilities 232 generate an appropriate instruction set by identifying the task's intent and mapping it to available tools, such as flow tools 252. The instruction interpreter 245 translates this generated instruction set into a script that is executable by the executor 244. The monitor 260 (such as via target analyzer 262) verifies that the resulting analysis meets performance criteria and, in certain embodiments, may automatically adjust one or more execution parameters to optimize congestion mitigation strategies. Updates and results are communicated back to the human user 280 via the email and API system 234.

In a third example, the WCA coordinates the placement of macros during a chip design flow, adjusting the arrangement of large design blocks within one or more designated tiles of the relevant chip layout. A message, such as “Optimize macro placement for Tile B,” is received by the WCA 200, such as from a human user 280 or from some other source (e.g., another WCA operating on the network). If predefined keywords (e.g., “macro placement,” “Tile B”) are detected, the instruction interpreter 245 retrieves a corresponding script from instruction data 335. This script is executed using one or more of tools 250 (such as flow tools 252) with parameters derived from the argument data 315. If any unexpected issues arise, such as macro-to-macro congestion, the monitor 260 identifies these via the target analyzer 262 and, in certain embodiments, generates follow-up actions, such as re-running the optimization with adjusted parameters.

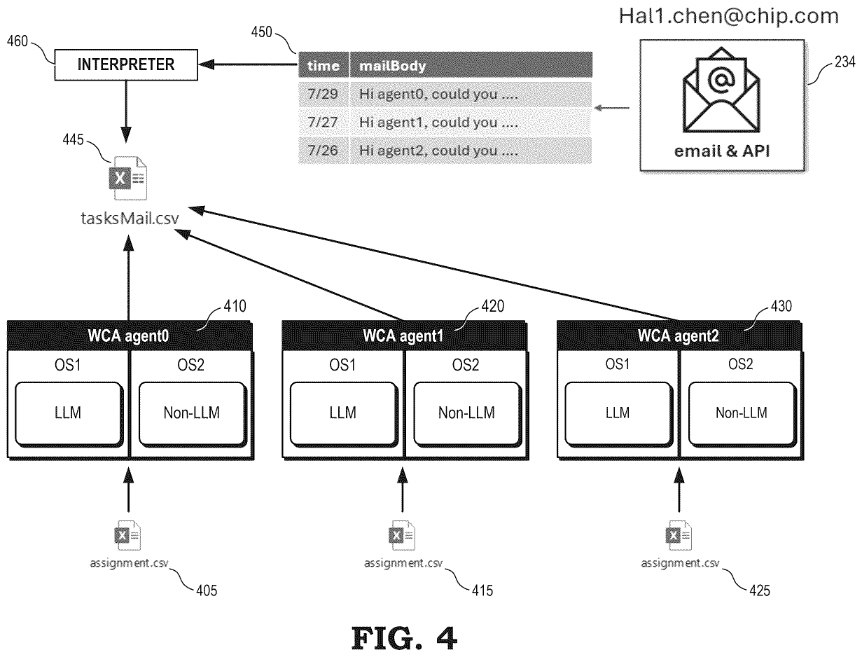

FIG. 4 illustrates an example workflow of a distributed network of workflow communications agents, demonstrating how multiple WCA instances handle incoming task-related messages in a networked environment, according to some embodiments. Each WCA instance in the system may operate across different servers or environments, managing both predefined and dynamically generated instruction sets through large language models (LLMs) and non-LLM facilities. The depicted example also shows how messages are parsed and assigned to the appropriate WCA agents for execution.

In operation, a message containing task-related content is received via the email and API system 234 from a human user (e.g., the human user associated with address/identifier Hal1.chen@chip.com). The content of the message is extracted and organized into message data 450 and recorded into tasks data 445, which stores the extracted message details such as time, sender, and content. These tasks are parsed and analyzed by the interpreter 460.

In some embodiments, the interpreter 460 is a component of the WCA 200. In such configurations, the interpreter processes the incoming messages and determines how to parse the content, identifying keywords or segments associated with predefined instructions. The interpreter directly interfaces with the WCA's instruction interpreter component to distribute tasks to the appropriate WCA instances for execution.

In other embodiments, the interpreter 460 may be a third-party tool invoked by the WCA 200 to handle the parsing process. In such cases, the WCA 200 programmatically invokes and communicates with the external interpreter, such as providing it with the contents of message data 450 for analysis. The external interpreter 460 processes the task-related content and returns results to the WCA 200, which then routes the tasks to the relevant workflow communications agents.

In certain embodiments, the tasks from tasks data 445 are assigned to different WCA agents based on the task content and system configuration. In the depicted example, three workflow communications agents—WCA agent0 410, WCA agent1 420, and WCA agent2 430—are distributed across different servers. The system assigns tasks to the appropriate WCA based on predefined rules or dynamically generated criteria, with task assignments stored in assignment data files 405, 415, and 425 for each respective WCA. Thus, in the depicted example, the tasks data 445 serves as the central repository for organizing the extracted message details, while the assignment data files 405, 415, 425 are used to track task assignments and ensure that each WCA agent receives the correct tasks based on the parsed message content.

Each WCA agent is responsible for executing its assigned tasks, and each instance is configured to run both LLM facilities and non-LLM facilities. These facilities are distributed across two operating systems (OS1 and OS2), as shown. In the depicted example, LLM facilities are operating under operating system OS1 and handle the interpretation of unstructured or dynamic task-related content, while non-LLM facilities operating under operating system OS2 manage predefined tasks and execution of structured instruction sets.

As shown, the system of workflow communications agents supports a multi-operating system environment, with each WCA running components across different servers or OS environments. As depicted, WCA agent0 410, WCA agent1 420, and WCA agent2 430 all run LLM facilities on OS1 and non-LLM facilities on OS2. This division allows for flexible handling of both predefined and dynamically generated tasks, ensuring that the system can efficiently process different types of instructions based on the resources available in each operating environment. However, it will be appreciated that in various embodiments and scenarios, other combinations of operating systems, servers, and WCAs are implemented in accordance with techniques presented herein.

Once tasks are assigned to the appropriate WCA agents, each agent initiates execution of those tasks based on their respective instruction sets. Each WCA agent accesses tools and resources required to complete the task, including interaction with internal or external systems. The WCAs communicate status updates back to the human user or other agents within the network through the email and API system 234. In some cases, messages between agents may also be handled autonomously by the WCA instances, generating further instructions or triggering additional workflows.

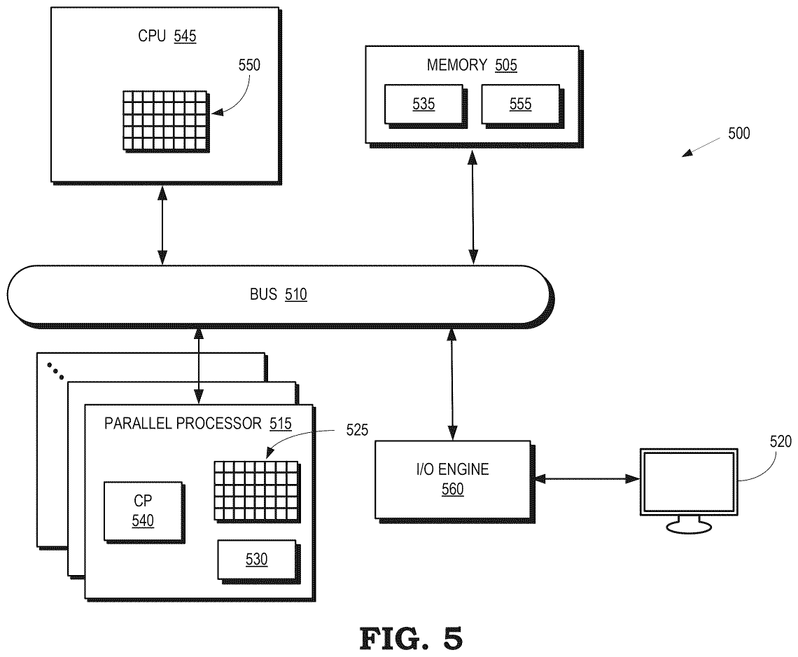

FIG. 5 is a block diagram of a processing system 500 designed to implement one or more instances of workflow communications agents in accordance with one or more embodiments. The processing system 500 is generally designed to execute sets of instructions or commands to carry out tasks on behalf of an electronic device, such as a desktop computer, laptop computer, server, smartphone, tablet, game console, and the like. In various embodiments, this processing system may be distributed across multiple servers or environments, managing the execution of both predefined and dynamically generated instruction sets associated with one or more hosted WCAs.

The processing system 500 includes or has access to a memory 505 or other storage component that is implemented using a non-transitory computer readable medium, such as dynamic random access memory (DRAM). The processing system 500 also includes a bus 510 to support communication between entities implemented in the processing system 500, such as the memory 505. In certain embodiments, the processing system 500 includes other buses, bridges, switches, routers, and the like, which are not shown in FIG. 5 in the interest of clarity.

The processing system 500 includes one or more parallel processors 515 that are configured to render images for presentation on a display 520. In the context of a WCA-based system, the parallel processors 515 may also handle tasks related to neural network processing, machine learning model inference, or data-driven optimization techniques as part of executing tasks managed by the WCA.

A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 515 can render objects to produce pixel values that are provided to the display 520. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 515 is also used for general-purpose computing. For instance, the parallel processor 515 can be used to implement machine learning algorithms such as one or more implementations of a neural network as described herein. The parallel processor 515 may also process complex instructions related to LLM facilities or task optimization routines. In some cases, operations of multiple parallel processors 515 are coordinated to execute a machine learning algorithm, such as if a single parallel processor 515 does not possess enough processing power to run the machine learning algorithm on its own.

The parallel processor 515 implements multiple processing elements (also referred to as compute units) 525 that are configured to execute instructions concurrently or in parallel. The parallel processor 515 also includes an internal (or on-chip) memory 530 that includes a local data store (LDS), as well as caches, registers, or buffers utilized by the compute units 525. The parallel processor 515 can execute instructions stored in the memory 505 and store information in the memory 505 such as the results of the executed instructions. The parallel processor 515 also includes a command processor 540 that receives task requests and dispatches tasks to one or more of the compute units 525.

The processing system 500 also includes a central processing unit (CPU) 545 that is connected to the bus 510 and communicates with the parallel processor 515 and the memory 505 via the bus 510. The CPU 545 implements multiple processing elements (also referred to as processor cores) 550 that are configured to execute instructions concurrently or in parallel. The CPU 545 can execute instructions such as program code 555 stored in the memory 505 and the CPU 545 can store information in the memory 505 such as the results of the executed instructions.

An input/output (I/O) engine 560 handles input or output operations associated with the display 520, as well as other elements of the processing system 500 such as keyboards, mice, printers, external disks, and the like. The I/O engine 560 is coupled to the bus 510 so that the I/O engine 560 communicates with the memory 505, the parallel processor 515, or the CPU 545.

In operation, the CPU 545 issues commands to the parallel processor 515 or other components of the system 500 to execute tasks related to instruction parsing, LLM operations, or dynamic task handling, and in some scenarios initiates processing of a kernel that represents the program instructions that are executed by the parallel processor 515. Multiple instances of the kernel, referred to herein as threads or work items, are executed concurrently or in parallel using subsets of the compute units 525. In some embodiments, the threads execute according to single-instruction-multiple-data (SIMD) protocols so that each thread executes the same instruction on different data. The threads are collected into workgroups (also termed thread groups) that are executed on different compute units 525. For example, the command processor 540 can receive these commands and schedule tasks for execution on the compute units 525.

In some embodiments, the parallel processor 515 implements a graphics pipeline that includes multiple stages configured for concurrent processing of different primitives in response to a draw call. Stages of the graphics pipeline in the parallel processor 515 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware-or software-implemented construct in a processing system, such as processing system 500. In various embodiments, such a layer may perform one or more operations via processing circuitry of the processing system 500 to serve as a collection or group of interconnected neurons or nodes, arranged in a structure that can be optimized for execution on one or more parallel processors (e.g., parallel processors 515) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 505) and manipulated by the central processing unit (CPU) 545 and/or the parallel processors 515.

In some instances, such layers may be distributed across multiple processing units within a system. For instance, different layers or groups of layers may be executed on different compute units 525 within a single parallel processor 515, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

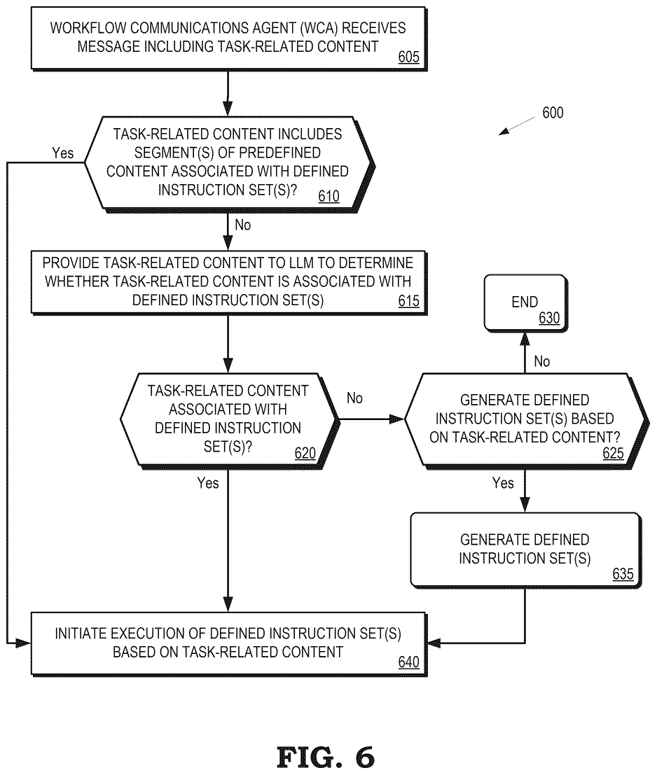

FIG. 6 illustrates an operational flow diagram of a routine 600 for processing task-related content via a workflow communications agent (WCA 200) in accordance with one or more embodiments. The operational flow diagram illustrates how the WCA processes task-related messages, determines if predefined instruction sets apply, and generates new instruction sets if necessary.

The routine begins at block 605, in which the WCA receives a message including task-related content. This message can be received from a human user or another agent within the system, such as via the email and API system 234, as described elsewhere herein. For example, the message may contain one or more instructions or requests related to a task.

At decision block 610, the WCA determines whether the task-related content includes one or more segments of predefined content, such as known instructions or keywords that have been associated with existing instruction sets (e.g., scripts) in the system. If the message contains any such segments of predefined content, the routine proceeds to block 640, in which the WCA initiates execution of one or more predefined instruction sets based on the task-related content.

If the task-related content does not include predefined content, the routine proceeds to block 615, where the WCA provides the task-related content to one or more large language models (LLMs). The LLMs are responsible for interpreting dynamic, unstructured content and determining whether it is associated with an existing instruction set. The LLM analyzes the message to infer any task instructions from the unstructured content.

At decision block 620, the WCA checks if the LLM has determined that the task-related content is associated with one or more defined instruction sets. If so, the routine moves to block 640 to initiate the execution of the associated instruction set(s). If not, the routine proceeds to decision block 625, where the WCA determines whether to generate new instruction sets based on the task-related content. In this manner, even if the message contains new or previously unseen content, the WCA can still generate an appropriate instruction set for execution.

If the WCA determines that it cannot generate an instruction set based on the task-related content, the routine proceeds to block 630 and terminates. If, however, the WCA determines that it can generate an instruction set, the routine proceeds to block 635, where the WCA generates one or more defined instruction sets based on the unstructured task-related content. These newly generated instruction sets may be based on the LLM's interpretation of the content or other logic embedded within the WCA.

At block 640, the WCA initiates execution of the defined instruction set(s), whether they were predefined (and identified in one of blocks 610 and 620) or newly generated (at block 635). In various embodiments and scenarios, the execution of these instruction sets can involve programmatically interacting with one or more tools to perform one or more task actions.

In some embodiments, the apparatus and techniques described above are implemented in a system including one or more integrated circuit (IC) devices (also referred to as integrated circuit packages or microchips), such as the workflow communications agent(s) described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation—[entity] configured to [perform one or more tasks]—is used herein to refer to physical structure (e.g., electronic circuitry). More specifically, this formulation is used to indicate that this physical structure is arranged to perform the one or more tasks during operation. Such physical structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, by a workflow communications agent (WCA) executing on one or more servers, a message including task-related content;
responsive to determining that the task-related content does not include one or more segments of predefined content that are respectively associated with one or more predefined instruction sets, providing the task-related content to one or more large language models to determine whether the task-related content is associated with at least one of the one or more predefined instruction sets; and
initiating, by the WCA and responsive to determining that the task-related content is associated with at least one predefined instruction set of the one or more predefined instruction sets, execution of the at least one predefined instruction set.

2. The method of claim 1, further comprising, responsive to determining that the task-related content is not associated with at least one predefined instruction set, generating one or more instruction sets based on the task-related content.

3. The method of claim 2, wherein initiating execution of the at least one predefined instruction set comprises initiating execution of the generated one or more instruction sets.

4. The method of claim 1, wherein the one or more servers comprises a first server using a first operating system and a second server using a second operating system different from the first operating system.

5. The method of claim 4, wherein determining whether the task-related content includes the one or more segments of predefined content is performed by the first server using the first operating system and wherein providing the task-related content to the one or more large language models comprises providing the task-related content to the second server.

6. The method of claim 1, wherein initiating execution of the at least one predefined instruction set comprises providing one or more parameters for the at least one predefined instruction set to a tool configured to perform at least some operations of the at least one predefined instruction set.

7. The method of claim 1, further comprising adjusting execution parameters for execution of the at least one predefined instruction set based on one or more performance metrics.

8. The method of claim 1, wherein the WCA is a first WCA associated with a first human user on a communications network, wherein a second human user of the communications network is associated with a second WCA, and wherein receiving the message including the task-related content comprises the first WCA receiving the message from the second WCA.

9. The method of claim 1, wherein the WCA is a first WCA associated with a first human user on a communications network, wherein a second human user of the communications network is associated with a second WCA, and wherein receiving the message including the task-related content comprises the first WCA receiving the message from the second human user.

10. A non-transitory computer readable medium embodying a set of executable instructions that, when executed by one or more processors, manipulate the one or more processors to perform a method, the method comprising:
receiving, by a workflow communications agent (WCA) executing on one or more servers, a message including task-related content;
responsive to determining that the task-related content does not include one or more segments of predefined content that are respectively associated with one or more predefined instruction sets, providing the task-related content to one or more large language models to determine whether the task-related content is associated with at least one of the one or more predefined instruction sets; and
initiating, by the WCA and responsive to determining that the task-related content is associated with at least one predefined instruction set of the one or more predefined instruction sets, execution of the at least one predefined instruction set.

11. A system comprising:
a memory;
one or more processors; and
a workflow communications agent (WCA) executing on the one or more processors, the WCA configured to:
receive a message that includes task-related content;
responsive to a determination that the task-related content does not include one or more segments of predefined content respectively associated with one or more defined instruction sets, provide the task-related content to one or more large language models to determine whether the task-related content is associated with at least one of the one or more defined instruction sets; and
responsive to a determination that the task-related content is associated with at least one defined instruction set of the one or more defined instruction sets, initiate execution of the at least one defined instruction set.

12. The system of claim 11, wherein the WCA is further configured to, responsive to determining that the task-related content is not associated with at least one defined instruction set, generate one or more instruction sets based on the task-related content.

13. The system of claim 12, wherein the WCA is configured to initiate execution of the generated one or more instruction sets.

14. The system of claim 11, wherein the one or more processors comprise a first processor operating a first operating system and a second processor operating a second operating system that is different from the first operating system.

15. The system of claim 14, wherein the determination that the task-related content does not include the one or more segments of predefined content is performed by the first processor operating the first operating system, and wherein to provide the task-related content to the one or more large language models comprises providing the task-related content to the second processor operating the second operating system.

16. The system of claim 11, wherein the WCA is configured to provide one or more parameters for the at least one defined instruction set to a tool configured to perform at least some operations of the at least one defined instruction set, wherein the tool is configured to perform one or more of a group that includes design generation, optimization, or compilation operations.

17. The system of claim 11, wherein the WCA is further configured to adjust execution parameters for execution of the at least one defined instruction set based on one or more performance metrics.

18. The system of claim 11, wherein the WCA is a first WCA that is associated with a first human user of a communications network, wherein a second human user of the communications network is associated with a second WCA, and wherein the first WCA is configured to receive the message that includes the task-related content from the second WCA.

19. The system of claim 11, wherein the WCA is a first WCA that is associated with a first human user of a communications network, wherein a second human user of the communications network is associated with a second WCA, and wherein the first WCA is configured to receive the message that includes the task-related content from the second human user.

20. The system of claim 11, wherein the system comprises a plurality of workflow communications agents (WCAs) executing on the one or more processors, each WCA associated with a respective human user, and wherein the WCAs are respectively configured to coordinate operations by:
receiving messages including task-related content from one or more other WCAs;
parsing each received message to determine whether the task-related content of the received message is associated with one or more defined instruction sets;
and coordinating task execution across the plurality of WCAs based on the task-related content and defined instruction sets.
